(19) United States
(12) Patent Application Publication
(10) Pub. No.: US 2013/0030204 A1
(43) Pub. Date: Jan. 31, 2013

(54) METHOD FOR THE MANUFACTURE OF AMINOPOLYALKYLENE PHOSPHONIC ACIDS

(71) Applicants: Patrick Notté, Wavre (BE); Cedric Nicolas Pirard, Romsee (Fleron) (BE); David Lemin, Watermael-Boitsfort (BE)

(72) Inventors: Patrick Notté, Wavre (BE); Cedric Nicolas Pirard, Romsee (Fleron) (BE); David Lemin, Watermael-Boitsfort (BE)

(73) Assignee: STRAITMARK HOLDING AG, Zug (CH)

(21) Appl. No.: 13/322,676

(22) PCT Filed: May 28, 2010
(86) PCT No.: PCT/EP10/57434

§ 371 Date: Feb. 17, 2012

(30) Foreign Application Priority Data
May 28, 2009 (EP) 09161389.3

(51) Int. Cl. C07F 9/38

(52) U.S. Cl. 554/84; 562/11

(57) ABSTRACT

A method for the manufacture of aminopolyalkylene phosphonic acid of a specific general formula is described. In particular, a mixture of specifically defined ranges of reactants to wit: phosphorous acid; an amine; formaldehyde and an aminopolyalkylene phosphonic acid, having the same general formula as the compound to be manufactured, are reacted to thus yield a product of outstanding selectivity and purity with substantially reduced levels of non-desirable by-products.

This invention pertains to a beneficially improved method for the manufacture of aminopolyalkylene phosphonic acids whereby the synthesis reaction is conducted in the presence of specifically defined levels of aminopolyalkylene phosphonic acid species having a formula corresponding to the class of compounds to be manufactured in accordance with the method herein. In a preferred aspect herein, the aminopolyalkylene phosphonic acid to be added to the reaction mixture is structurally substantially identical to the compound to be manufactured. The manufacturing method of this invention is premised on using selective ratios of the reactants, inter alia, the use of a major, as compared to the levels of the other reactants, and narrowly defined level of the aminopolyalkylene phosphonic acid to thus yield reaction products of high uniformity, purity and yield.

Aminoalkylene phosphonic acid compounds are generally old in the art and have found widespread commercial acceptance for a variety of applications including water-treatment, scale-inhibition, detergent additives, sequestrants, marine-oil drilling adjuvents and as pharmaceutical components. It is well known that such industrial applications preferably require amino alkylene phosphonic acids wherein a majority of the N—H functions of the ammonia/amine raw material have been converted into the corresponding alkylene phosphonic acid. The art is thus, as one can expect, crowded and is possessed of methods for the manufacture of such compounds. The state-of-the-art manufacture of amino alkylene phosphonic acids is premised on converting phosphorous acid resulting from the hydrolysis of phosphorus trichloride or on converting phosphorous acid via the addition of hydrochloric acid which hydrochloric acid can be, in part or in total, added in the form of an amine hydrochloride.

The manufacture of amino alkylene phosphonic acids is described in GB 1.142.294. This art is premised on the exclusive use of phosphorus trihalides, usually phosphorus trichloride, as the source of the phosphorous acid reactant. The reaction actually requires the presence of substantial quantities of water, frequently up to 7 moles per mole of phosphorus trihalide. The water serves for the hydrolysis of the phosphorus trichloride to thus yield phosphorous and hydrochloric acids. Formaldehyde losses occur during the reaction which is carried out at mild temperatures in the range of from 30-60° C. followed by a short heating step at 100-120° C. GB 1.230.121 describes an improvement of the technology of GB 1.142.294 in that the alkylene polyaminomethylene phosphonic acid may be made in a one-stage process by employing phosphorus trihalide instead of phosphorous acid to thus secure economic savings. The synthesis of aminomethylene phosphonic acids is described by Moedritzer and Irani, J. Org. Chem., Vol 31, pages 1603-1607 (1966). Mannich-type reactions, and other academic reaction mechanisms, are actually disclosed. Optimum Mannich conditions require low-pH values such as resulting from the use of 2-3 moles of concentrated hydrochloric acid/mole of amine hydrochloride. The formaldehyde component is added drop wise, at reflux temperature, to the reactant solution mixture of aminehydrochloride, phosphorous acid and concentrated hydrochloric acid. U.S. Pat. No. 3,288,846 also describes a process for preparing aminoalkylene phosphonic acids by forming an aqueous mixture, having a pH below 4, containing an amine, an organic carbonyl compound e.g. an aldehyde or a ketone, and heating the mixture to a temperature above 70° C. whereby the amino alkylene phosphonic acid is formed. The reaction is conducted in the presence of halide ions to thus inhibit the oxidation of orthophosphorous acid to orthophosphoric acid. WO 96/40698 concerns the manufacture of N-phosphonomethyliminodiacetic acid by simultaneously infusing into a reaction mixture water, iminodiacetic acid, formaldehyde, a source of phosphorous acid and a strong acid. The source of phosphorous acid and strong acid are represented by phosphorus trichloride.

The use of phosphorus trichloride for preparing aminopolyalkylene phosphonic acids is, in addition, illustrated and emphasized by multiple authors such as Long et al. and Tang et al. in Huaxue Yu Nianhe, 1993 (1), 27-9 and 1993 34(3), 111-14 respectively. Comparable technology is also known from Hungarian patent application 36825 and Hungarian patent 199488. EP 125766 similarly describes the synthesis of such compounds in the presence of hydrochloric acid.

EP 1681295 describes the manufacture of aminoalkylene phosphonic acids under substantial exclusion of hydrohalogenic acid by reacting phosphorous acid, an amine and formaldehyde in the presence of a heterogeneous Broensted acid catalyst. Suitable catalyst species can be represented by fluorinated carboxylic acids and fluorinated sulfonic acids having from 6 to 24 carbon atoms in the hydrocarbon chain. EP 1681294 pertains to a method for the manufacture of aminopolyalkylene phosphonic acids under substantial exclusion of hydrohalogenic acid by reacting phosphorous acid, an amine and formaldehyde in the presence of a homogeneous acid catalyst having a pKa equal to or smaller than 3.1. The acid catalyst can be represented by sulphuric acid, sulfurous acid, trifluoroacetic acid, trifluoromethane sulfonic acid, oxalic acid, malonic acid, p-toluene sulfonic acid and naphthalene sulfonic acid. EP 2 112 156 describes the manufacture of aminoalkylene phosphonic acids by adding P₄O₆ to an aqueous reaction medium containing a homogeneous Broensted acid whereby the aqueous medium can contain an amine or wherein the amine is added simultaneously with the P₄O₆ or wherein the amine is added after completion of the P₄O₆ addition, whereby the pH of the reaction medium is maintained at all times below 5 and whereby the reaction partners, phosphorous acid/amine/formaldehyde/Broensted acid, are used in specifically defined proportions.

JP patent application 57075990 describes a method for the manufacture of diaminoalkane tetra(phosphonomethyl) by reacting formaldehyde with diaminoalkane and phosphorous acid in the presence of a major level of concentrated hydrochloric acid.

Phosphorus oxides and the hydrolysis products thereof are extensively described in the literature. Canadian patent application 2.070.949 divulges a method for the manufacture of phosphorous acid, or the corresponding P₂O₃ oxide, by introducing gaseous phosphorus and steam water into a gas plasma reaction zone at a temperature in the range of 1500° K to 2500° K to thus effect conversion to P₂O₃ followed by rapidly quenching the phosphorus oxides at a temperature above 1500° K with water to a temperature below 1100° K to thus yield H₃P0₃ of good purity. In another approach, phosphorus(I) and (III) oxides can be prepared by catalytic reduction of phosphorus(V) oxides as described in U.S. Pat. No. 6,440,380. The oxides can be hydrolyzed to thus yield phosphorous acid. EP-A-1.008.552 discloses a process for the preparation of phosphorous acid by oxidizing elemental phosphorus in the presence of an alcohol to yield P(III) and P(V) esters followed by selective hydrolysis of the phosphite ester into phosphorous acid. WO 99/43612 describes a catalytic process for the preparation of P(III) oxyacids in high selectivity. The catalytic oxidation of elemental phosphorus to phosphorous oxidation levels is also known from U.S. Pat. Nos. 6,476,256 and 6,238,637.

DD 206 363 discloses a process for converting P₄O₆ with water into phosphorous acid in the presence of a charcoal catalyst. The charcoal can serve, inter alia, for separating impurities, particularly non-reacted elemental phosphorus. DD 292 214 also pertains to a process for preparing phosphorous acid. The process, in essence, embodies the preparation of phosphorous acid by reacting elementary phosphorus, an oxidant gas and water followed by submitting the reaction mixture to two hydrolysing steps namely for a starter at molar proportions of P₄: H₂O of 1:10-50 at a temperature of preferably 1600-2000° K followed by completing the hydrolysis reaction at a temperature of 283-343° K in the presence of a minimal amount of added water.

However, quite in general, P₄O₆ is not available commercially and has not found commercial application. The actual technology used for the manufacture of aminoalkylene phosphonic acids is based on the PCl₃ hydrolysis with its well known deficiencies ranging from the presence of hydrochloric acid, losses of PCl₃ due to volatility and entrainement by HCl and the formation of chlorine containing by-products e.g. methyl chloride.

While the art pertaining to aminopolyalkylene phosphonic acids is diverse and representative of R&D efforts expanded over a period of several decades, the technology has basically remained of what it was and there is a strong desire for making available significant improvements.

It is a major object of this invention to generate aminopolyalkylene phosphonic acid (APAP) manufacturing technology capable of delivering significantly improved products. It is another object of this invention to provide a substantially simplified APAP manufacturing arrangement capable of yielding superior products. Yet another object of this invention aims at providing a manufacturing sequence which does not require any removal, isolation or destruction of the catalyst. Yet another general object pertains to achieving all the foregoing benefits under substantial exclusion of hydrohalogenics. This invention also aims at synthesizing APAP having the recited beneficial properties, starting from P(III)-oxides.

The term “percent” or “%” as used throughout this application stands, unless defined differently, for “percent by weight” or “% by weight”. The terms “phosphonic acid” and “phosphonate” are also used interchangeably depending, of course, upon medium prevailing alkalinity/acidity conditions. The term “ppm” stands for “parts per million”. The terms “P₂O₃” and “P₄O₆” can be used interchangeably. Unless defined differently, pH values are measured at 25° C. on the reaction medium as such. The term “poly” in “aminopolyalkylene phosphonic acid” means that at least two alkylene phosphonic acid moieties are present in the compound. The designation “phosphorous acid” means phosphorous acid as such, phosphorous acid prepared in situ starting from P₄O₆ or purified phosphorous acid starting from PCl₃ or purified phosphorous acid resulting from the reaction of PCl₃ with carboxylic acid, sulfonic acid or alcohol to make the corresponding chloride. The term “amine” embraces amines per se and ammonia. The term “formaldehyde component” designates interchangeably formaldehyde, sensu stricto, aldehydes and ketones. The term amino acid stands for amino acids in their D, L and DL forms as well as mixtures of the D and L forms. The term “optionally substituted” means that the specified group is unsubstituted or substituted by one or more substituents, independently chosen from the group of possible substituents.

“The term “liquid P₄O₆” embraces P₄O₆ in the liquid state, solid P₄O₆and gaseous P₄O₆. The term “ambient” with respect to temperature and pressure means usually prevailing terrestrial conditions at sea level e.g. temperature is about 18° C.-25° C. and pressure stands for 990-1050 mm Hg.

The recited and other objects can now be met by a method for the manufacture of aminopolyalkylene phosphonic acids, having a specific structural formula, by reacting phosphorous acid, an amine and formaldehyde in the presence of an aminopolyalkylene phosphonic acid having the same structural formula as the aminopolyalkylene phosphonic acid to be manufactured. In detail, the Applicant has now discovered a new manufacturing method for synthesizing aminopolyalkylene phosphonic acids thereby yielding products of high selectivity and purity with significantly reduced levels of by-products under substantial exclusion of catalysts which are foreign to the system, i.e.

the reaction medium. The claimed invention relates to a method for the manufacture of aminopolyalkylene phosphonic acid having the general formula (I)

(X)ₐ[N(W)(Y)₂₋ₐ]_{z} (I)

wherein X is selected from C₁-C₂₀₀₀₀₀, preferably C₁-C₅₀₀₀₀, most preferably C₁-C₂₀₀₀, linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOG, F, Br, Cl, I, OG, SO₃H, SO₃G and/or SG moieties; ZPO₃M₂; [V—N(K)]ₙ—K; [V—N(Y)]ₙ—V or [V—O]ₓ—V; wherein V is selected from: C₂₋₅₀ linear, branched, cyclic or aromatic hydrocarbon radicals, optionally substituted by one or more C₁₋₁₂ linear, branched, cyclic or aromatic groups, which radicals and/or groups are optionally substituted by OH, COOH, COOR′, F/Br/Cl/I, OR′, SO₃H, SO₃R′ and/or SR′ moieties, wherein R′ is a C₁₋₁₂ linear, branched, cyclic or aromatic hydrocarbon radical, wherein G is selected from C₁-C₂₀₀₀₀₀, preferably C₁-C₅₀₀₀₀, most preferably C₁-C₂₀₀₀, linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOR′, F, Br, Cl, I, OR′, SO₃H, SO₃R′ and/or SR′ moieties; ZPO₃M₂; [V—N(K)]ₙ—K; [V—N(Y)]ₙ—V or [V—O]ₓ—V; wherein Y is ZPO₃M₂, [V—N(K)]ₙ—K or [V—N(K)]ₙV; and x is an integer from 1-50000; z is from 0-200000, whereby z is equal to or smaller than the number of carbon atoms in X, and a is 0 or 1; n is an integer from 1 to 50000; z=1 when a=0; and X is [V—N(K)]ₙ—K wherein n is an integer from 1 to 50000 or [V—N(Y)]ₙ—V wherein n is an integer from 2 to 50000 when z=0 and a=1;

Z is a methylene group;

M is selected from H, protonated amine, ammonium, alkali and earth-alkalications;

W is ZPO₃M₂;

K is ZPO₃M₂;

starting from:

(a) phosphorous acid or an aqueous solution thereof;

(b) an amine or an aqueous solution thereof;

(c) a formaldehyde component or an aqueous solution thereof; and

(d) an aminopolyalkylene phosphonic acid or an aqueous solution thereof;

whereby (a), (b) and (d) are mixed followed by the addition of the formaldehyde component (c);

wherein the amine has the general formula (II)

(X)_{b}[N(W)(H)_{2-b}]_{z} (II)

wherein X is selected from C₁-C_{200000,} ^{preferably C}_{1-50000,} most preferably C₁₋₂₀₀₀, linear, branched, cyclic or aromatic hydrocarbon radicals, optionally substituted by one or more C₁-C₁₂ linear, branched, cyclic or aromatic groups which radicals and/or which groups are optionally substituted by OH, COOH, COOG, F, Br, Cl, I, OG, SO₃H, SO₃G and/or SG moieties; H; [V—N(H)]_{X}H or [V—N(Y)]ₙ—V or [V—O]ₓ—V; wherein V is selected from: C₂₋₅₀ linear, branched, cyclic or aromatic hydrocarbon radicals, optionally substituted by one or more C₁₋₁₂ linear, branched, cyclic or aromatic groups, which radicals and/or groups are optionally substituted by OH, COOH, COOR′, F/Br/Cl/I, OR′, SO₃H, SO₃R′ and/or SR′ moieties, wherein R′ is a C₁₋₁₂ linear, branched, cyclic or aromatic hydrocarbon radical; wherein G is selected from C₁-C₂₀₀₀₀₀, preferably C₁-C₅₀₀₀₀, most preferably C₁-C₂₀₀₀, linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOR′, F, Br, Cl, I, OR′, SO₃H, SO₃R′ and/or SR′ moieties; H; [V—N(H)]ₙ—H; [V—N(Y)]ₙ—V or [V—O]ₓ—V; wherein Y is H, [V-N(H)]ₙ—H or [V—N(H)]ₙ—V and x is an integer from 1-50000, n is an integer from 0 to 50000; z is from 0-200000, whereby z is equal to or smaller than the number of carbon atoms in X, and b is 0 or 1; z=1 when b=0; and X is [V—N(H)]ₓ—H or [V—N(Y)]ₙ—V, n is an integer from 1 to 50000 when z=0 and b=1; z=1 when X is H.

W is H;

whereby the aminopolyalkylene phosphonic acid (d) has a general formula which is identical to the general formula of the aminopolyalkylene phosphonic acid to be manufactured;

whereby the ratios of: (a) phosphorous acid, (b) amine, (d) aminopolyalkylene phosphonic acid and (c) formaldehyde component, are as follows:

(a):(b) of from 0.05:1 to 2:1;

(c):(b) of from 0.05:1 to 5:1;

(c):(a) of from 5:1 to 0.25:1; and

(b):(d) of from 30:1 to 1:2;

wherein (a) and (c) stand for the number of moles and (b) represents the number of moles multiplied by the number of N—H functions in the amine and (d) stands, for the homogeneous aminopolyalkylene phosphonic acid expressed in number of moles;

conducting the reaction at a temperature of from 45° C. to 200° C. for a period of 1 minute to 10 hours to thus yield the amino polyalkylene phosphonic acid.

The preferred ratios are as follows:

(a):(b) of from 0.1:1 to 1.50:1;

(c):(b) of from 0.2:1 to 2:1; and

(c):(a) of from 3:1 to 0.5:1.

Particularly preferred ratios are:

(a):(b) of from 0.4:1 to 1.0:1.0;

(c):(b) of from 0.4:1 to 1.5:1; and

(c):(a) of from 2:1 to 1.0:1.

The preferred ratios with respect to the aminopolyalkylene phosphonic acid (d) acid are:

(b):(d) of from 20:1 to 1:2;

particularly preferred, in that respect, are:

(b):(d) of from 10:1 to 1:2.

In a preferred embodiment in the method herein, the homogeneous aminopolyalkylene phosphonic acid catalyst (d) can be used together with, and substituted in part by, a heterogeneous Broensted acid catalyst.

Homogeneous catalysts are catalysts adapted to form a single liquid phase within the reaction medium under the reaction conditions. It is understood that catalysts which are insoluble or immiscible in the reaction medium, and thus non-homogeneous, at ambient conditions e.g. 20° C., can become miscible or soluble at e.g. the reaction temperature and thus qualify as “homogeneous”. The term heterogeneous means that the acid catalyst is substantially insoluble in the reaction medium, at the reaction conditions, or substantially immiscible, thus liquid, in the reaction medium at the reaction conditions. The insoluble and/or immiscible nature of the catalyst can be ascertained routinely e.g. based on visible observation. The acid catalyst may be recovered from the reaction medium by known techniques such as e.g. filtration of insoluble acids or phase separation of immiscible acids.

Specifically, the phosphonic acid catalyst (d) can be substituted by a mixture of the aminopolyalkylene phosphonic acid catalyst (d) together with a heterogeneous Broensted acid whereby the phosphonic acid (d) represents 50% or more, expressed on the basis of the total proton equivalents and calculated as indicated below, of the mixture of (d) and the heterogeneous Broensted acid. In one particular execution, 90 to 60% of the proton equivalents of catalyst (d) can originate from the aminopolyalkylene phosphonic acid and 10 to 40% from the heterogeneous Broensted acid. The partial replacement of the phosphonic acid (d) by the heterogeneous Broensted acid can be expressed as follows. The number of proton equivalents in the heterogeneous Broensted acid as a partial replacement of the aminopolyalkylene phosphonic acid can be calculated from the number of moles of aminopolyalkylene phosphonic acid to be replaced multiplied by the number of PO₃H₂ groups in the phosphonic acid minus the number of nitrogen atoms in the aminopolyalkylene phosphonic acid catalyst. Formulawise this relationship can be expressed as follows:

number of mole(s) of aminopolyalkylene phosphonic acid to be replaced=APP^{m}; number of PO₃H₂ groups in the phosphonic acid=PH^{m};

number of nitrogen atoms in the aminopolyalkylene phosphonic acid catalyst=N^{m};

APP^{m}(PH^{m}−N^{m}).

The heterogeneous Broensted acid for use as a partial replacement of (d) can be selected from the group of:

(1) solid acidic metal oxide combinations as such or supported onto a carrier material;

(2) cation exchange resins selected from the group comprising copolymers of styrene, ethylvinyl benzene and divinyl benzene, functionalized so as to graft SO₃H moieties onto the aromatic group and perfluorinated resins

(3) organic sulfonic and carboxylic Broensted acids which are substantially immiscible in the reaction medium at the reaction temperature;

(4) an acid catalyst derived from:
i) the interaction of a solid support having a lone pair of electrons onto which is deposited an organic Broensted acid; or
(ii) the interaction of a solid support having a lone pair of electrons onto which is deposited a compound having a Lewis acid site;
(iii) heterogeneous solids functionalized by chemical grafting with a Broensted acid group or a precursor therefore, and

(5) heterogeneous heteropolyacids of the general formula HₓPM_{y}O_{z} wherein P is selected from phosphorus and silicon and M is selected from W and Mo and combinations thereof.

The Broensted properties represent the capabilities of supplying protons. Broensted acidity can also originate from Lewis acid properties after coordination of the Lewis site on the catalyst with a lone pair of electrons in a coordination partner e.g. water. The Broensted acidity can also be derived from the addition of a Lewis acid e.g. BF₃ to the Broensted acid catalyst precursor having a lone pair of electrons and being capable of coordinating with the Lewis acid e.g. silica.

The Broensted properties of any given acid are readily and routinely ascertainable. As an example, the Broensted acidity can be determined, for thermally stable inorganic products, by e.g. thermal desorption of isopropylamine followed by using a microbalance in accordance with the method of R. J. Gorte et al., J.Catal. 129, 88, (1991) and 138, 714, (1992).

The heterogeneous Broensted acid properties, can, by way of example, be represented by species of discretionary selected subclasses, namely:

(1) solid catalysts represented by acidic metal oxide combinations which can be supported onto usual carrier materials such as silica, carbon, silica-alumina combinations or alumina. These metal oxide combinations can be used as such or with inorganic or organic acid doping. Suitable examples of this class of catalysts are amorphous silica-alumina, acid clays, such as smectites, inorganic or organic acid treated clays, pillared clays, zeolites, usually in their protonic form, and metal oxides such as ZrO₂—TiO₂ in about 1:1 molar combination and sulfated metal oxides e.g. sulfated ZrO₂. Other suitable examples of metal oxide combinations, expressed in molar ratios, are: TiO₂—SiO₂ 1:1 ratio; and ZrO₂—SiO₂ 1:1 ratio.

(2) several types of cation exchange resins can be used as acid catalyst to carry out the reaction of an amine, phosphorous acid and a formaldehyde. Most commonly, such resins comprise copolymers of styrene, ethylvinyl benzene and divinyl benzene functionalized so as to graft SO₃H groups onto the aromatic groups. Such resins are used as acidic catalysts in numerous commercial productions like e.g. in methyl t-butyl ether manufacturing from methanol and isobutene or in bisphenol A manufacturing starting from acetone and phenol. These acidic resins can be used in different physical configurations such as in gel form, in a macro-reticulated configuration or supported onto a carrier material such as silica or carbon or carbon nanotubes. Other types of resins include perfluorinated resins carrying carboxylic or sulfonic acid groups or both carboxylic and sulfonic acid groups. Known examples of such resins are: NAFION™, FLEMION™ and NEOSEPTA-F™. The fluorinated resins can be used as such or supported onto an inert material like silica or carbon or carbon nanotubes entrapped in a highly dispersed network of metal oxides and/or silica.

FLEMION is a Trademark of Asahi Glass, Japan

NEOSEPTA is a Trademark of Tokuyama Soda, Japan

NAFION is a trademark of DuPont, USA.

(3) a Broensted acid, such as an organic Broensted acid, which is substantially insoluble or immiscible in the reaction medium. The acid can form, at the reaction conditions, in particular the reaction temperature, a second liquid phase and can be recovered at the end of the reaction by conventional techniques such as filtration or phase separation. Examples of suitable acidic reagents include highly fluorinated, which means that 50% or more of the hydrogen atoms attached to the carbon atoms have been substituted by fluorine atoms, long chain sulfonic or carboxylic acids like perfluorinated undecanoic acid or more in particular perfluorinated carboxylic acid and perfluorinated sulfonic acids having from 6 to 24 carbon atoms. Such perfluorinated acid catalysts can be substantially immiscible in the reaction medium. The reaction will take place in a reactor under continuous stirring to ensure an adequate dispersion of the acid phase into the aqueous phase. The acidic reagent may itself be diluted into a water insoluble phase such as e.g. a water insoluble ionic liquid;

(4) heterogeneous solids, having usually a lone pair of electrons, like silica, silica-alumina combinations, alumina, zeolites, silica, activated charcoal, sand and/or silica gel can be used as support for a Broensted acid catalyst, like methane sulfonic acid or para-toluene sulfonic acid, or for a compound having a Lewis acid site, such as SbF₅, to thus interact and yield strong Broensted acidity. Heterogeneous solids, like zeolites, silica, or mesoporous silica e.g. MCM-41 or −48, or polymers like e.g. polysiloxanes can be functionalized by chemical grafting with a Broensted acid group or a precursor therefore to thus yield acidic groups like sulfonic and/or carboxylic acids or precursors therefore. The functionalization can be introduced in various ways known in the art like: direct grafting on the solid by e.g. reaction of the SiOH groups of the silica with chlorosulfonic acid; or can be attached to the solid by means of organic spacers which can be e.g. a perfluoro alkyl silane derivative. Broensted acid functionalized silica can also be prepared via a sol gel process, leading to e.g. a thiol functionalized silica, by co-condensation of Si(OR)₄ and e.g. 3-mercaptopropyl-tri-methoxy silane using either neutral or ionic templating methods with subsequent oxidation of the thiol to the corresponding sulfonic acid by e.g. H₂O₂. The functionalized solids can be used as is, i.e. in powder form, in the form of a zeolitic membrane, or in many other ways like in admixture with other polymers in membranes or in the form of solid extrudates or in a coating of e.g. a structural inorganic support e.g. monoliths of cordierite; and

(5) heterogeneous heteropolyacids having most commonly the formula HₓPM_{y}O_{z}. In this formula, P stands for a central atom, typically silicon or phosphorus. Peripheral atoms surround the central atom generally in a symmetrical manner. The most common peripheral elements, M, are usually Mo or W although V, Nb, and Ta are also suitable for that purpose. The indices _{xyz} quantify, in a known manner, the atomic proportions in the molecule and can be determined routinely. These polyacids are found, as is well known, in many crystal forms but the most common crystal form for the heterogeneous species is called the Keggin structure. Such heteropolyacids exhibit high thermal stability and are non-corrosive. The heterogeneous heteropolyacids are preferably used on supports selected from silica gel, kieselguhr, carbon, carbon nanotubes and ion-exchange resins. A preferred heterogeneous heteropolyacid herein can be represented by the formula H₃PM₁₂O₄₀ wherein M stands for W and/or Mo. Examples of preferred PM moieties can be represented by PW₁₂, PMo₁₂, PW₁₂/SiO₂, PW₁₂/carbon and SiW₁₂.

The aminopolyalkylene phosphonic acid catalyst (d), for use in the method of manufacture as claimed herein, has a general formula which is identical to the general formula (I) of the aminopolyalkylene phosphonic acid to be manufactured. In particularly preferred executions, the phosphonic acid (d) has a structural formula which is identical to the structural formula of the aminopolyalkylene phosphonic acid to be manufactured in the inventive method. Such ultra uniform reaction systems using a single structurally identical aminopolyalkylene phosphonic acid as a starting catalyst in the reaction mixture with a view to produce an identical end product were found to yield significant benefits including ease of manufacturing operation, purity, yield and selectivity. These benefits are, by any standard, meaningful and necessarily translate in major application and economic benefits. It is appreciated that the inventive technology is not subject to “catalyst residues” in the final product and/or to separation and purification procedures which are costly and of limited efficiency. The aminopolyalkylene phosphonic acid catalyst (d) may be a polyacid with at least two alkylene phosphonic acid moieties. Preferably, the aminopolyalkylene phosphonic acid catalyst (d) may have at least one phosphonic acid moiety having a pKa higher than 3.1.

In the invention herein, the sum of the number of phosphonic acid groups in the aminopolyalkylene phosphonic acid catalyst (d) herein is greater than, by at least one (integer), the sum of the number of N atoms in said aminopolyalkylene phosphonic acid (d) catalyst.

The phosphorous acid reactant is a commodity material well known in the domain of the technology. It can be prepared, for example, by various technologies some of which are well known, including hydrolysing phosphorus trichloride or P-oxides. Phosphorous acid and the corresponding P-oxides can be derived from any suitable precursor including naturally occurring phosphorus containing rocks which can be converted, in a known manner, to elemental phosphorus followed by oxidation to P-oxides and possibly phosphorous acid. The phosphorous acid reactant can also be prepared, starting from hydrolyzing PCl₃ and purifying the phosphorous acid so obtained by eliminating hydrochloric acid and other chloride intermediates originating from the hydrolysis. In a preferred execution, the chlorine level shall be less than 400 ppm, expressed in relation to the phosphorous acid (100%). In another approach, phosphorous acid can be manufactured beneficially by reacting phosphorus trichloride with a reagent which is either a carboxylic acid or a sulfonic acid or an alcohol. The PCl₃ reacts with the reagent under formation of phosphorous acid and an acid chloride in the case of an acid reagent or a chloride, for example an alkylchloride, originating from the reaction of the PCl₃ with the corresponding alcohol. The chlorine containing products, e.g. the alkylchloride and/or the acid chloride, can be conveniently separated from the phosphorous acid by methods known in the art e.g. by distillation. While the phosphorous acid so manufactured can be used as such in the claimed arrangement, it can be desirable and it is frequently preferred to purify the phosphorous acid formed by substantially eliminating or diminishing the levels of chlorine containing products and non-reacted raw materials. Such purifications are well known and fairly standard in the domain of the relevant manufacturing technology. Suitable examples of such technologies include the selective adsorption of the organic impurities on activated carbon or the use of aqueous phase separation for the isolation of the phosphorous acid component. Information pertinent to the reaction of phosphorous trichloride with a reagent such as a carboxylic acid or an alcohol can be found in Kirk-Othmer, Encyclopedia of Chemical Technology, in chapter Phosphorous Compounds, Dec. 4, 2000, John Wiley & Sons Inc.

In a preferred execution herein, the phosphorous acid reactant can be prepared by adding P₄O₆ to the reaction medium, said reaction medium having at all times a pH below 5, containing, as a pH regulator, the required level of the aminopolyalkylene phosphonic acid catalyst (d). The reaction medium can possibly contain the amine reactant (II), or the amine reactant (II) can be added simultaneously with the P₄O₆. The amine reactant (II) can also be added to the reaction medium after the hydrolysis of the P₄O₆ has been completed before the addition of the formaldehyde component. In any case, the balance of the aminopolyalkylene phosphonic acid catalyst is also added before the addition of the formaldehyde component. The simultaneous addition of the amine (II) and the P₄O₆ shall preferably be effected in parallel i.e. a premixing, before adding to the reaction medium, of the amine (II) and the P₄O₆ shall for obvious reasons be avoided.

The P₄O₆ can be represented by a substantially pure compound containing at least 85%, preferably more than 90%; more preferably at least 95% and in one particular execution at least 97% of the P₄O₆. While tetraphosphorus hexa oxide, suitable for use within the context of this invention, can be manufactured by any known technology, in preferred executions the hexa oxide can be prepared in accordance with the process disclosed in WO 2009/068636 entitled “Process for the manufacture of P₄O₆” and/or WO 2010/055056, entitled “Process for the manufacture of P₄O₆ with improved yield”.

In detail, oxygen, or a mixture of oxygen and inert gas, and gaseous or liquid phosphorus are reacted in essentially stoichiometric amounts in a reaction unit at a temperature in the range from 1600 to 2000° K, by removing the heat created by the exothermic reaction of phosphorus and oxygen, while maintaining a preferred residence time of from 0.5 to 60 seconds followed by quenching the reaction product at a temperature below 700° K and refining the crude reaction product by distillation. The hexa oxide so prepared is a pure product containing usually at least 97% of the oxide. The P₄O₆ so produced is generally represented by a liquid material of high purity containing in particular low levels of elementary phosphorus, P₄, preferably below 1000 ppm, expressed in relation to the P₄O₆ being 100%. The preferred residence time is from 5 to 30 seconds, more preferably from 8 to 30 seconds. The reaction product can, in one preferred execution, be quenched to a temperature below 350° K.

The term “liquid P₄O₆ ” embraces as spelled out, any state of the P₄O₆. However, it is presumed that the P₄O₆, participating in a reaction of from 45° C. to 200° C. is necessarily liquid or gaseous although solid species can, academically speaking, be used in the preparation of the reaction medium.

The P₄O₆ (mp. 23.8° C.; bp. 173° C.) in liquid form is added to the aqueous reaction medium containing the aminopolyalkylene phosphonic acid catalyst (d). The pH of the reaction medium is at all times after the addition of catalyst (d) maintained below 5.

This reaction medium thus contains the P₄O₆ hydrolysate and the amine, possibly as a salt. The hydrolysis is conducted at ambient temperature conditions (20° C.) up to about 150° C. While higher temperatures e.g. up to 200° C., or even higher, can be used such temperatures generally require the use of an autoclave or can be conducted in a continuous manner, possibly under autogeneous pressure built up. The temperature increase during the P₄O₆ addition can result from the exothermic hydrolysis reaction and was found to provide temperature conditions to the reaction mixture as can be required for the reaction with formaldehyde.

The reaction in accordance with this invention is conducted in a manner routinely known in the domain of the technology. As illustrated in the experimental showings, the method can be conducted by combining the essential reaction partners and heating the reaction mixture to a temperature usually within the range of from 45° C. to 200° C., and higher temperatures if elevated pressures are used, more preferably 70° C. to 150° C. The upper temperature limit actually aims at preventing any substantially undue thermal decomposition of the phosphorous acid reactant. It is understood and well known that the decomposition temperature of the phosphorous acid, and more in general of any other individual reaction partners, can vary depending upon additional physical parameters, such as pressure and the qualitative and quantitative parameters of the ingredients in the reaction mixture.

The inventive method can be conducted under substantial exclusion of added water beyond the stoichiometric level required for the hydrolysis of the P₄O₆. However, it is understood that the reaction inherent to the inventive method i.e. the formation of N—C—P bonds will generate water.

After the P₄O₆ hydrolysis has been completed, the amount of residual water is such that the weight of water is from 0% to 60% expressed in relation to the weight of the amine. The inventive reaction can be conducted at ambient pressure and, depending upon the reaction temperature, under distillation of water, thereby also eliminating a minimal amount of non-reacted formaldehyde component. The duration of the reaction can vary from virtually instantaneous, e.g. 1 minute, to an extended period of e.g. 10 hours. This duration generally includes the gradual addition, during the reaction, of formaldehyde component and possibly other reactants. In one method set up, the phosphorous acid, the amine (II) and the acid catalyst are added to the reactor followed by heating this mixture under gradual addition of the formaldehyde component starting at a temperature e.g. in the range of from 70° C. to 150° C. This reaction can be carried out under ambient pressure with or without distillation of usually water and some non-reacted formaldehyde.

In another operational arrangement, the reaction can be conducted in a closed vessel under autogeneous pressure built up. In this method, the reaction partners, in total or in part, are added to the reaction vessel at the start. In the event of a partial mixture, the additional reaction partner can be gradually added, alone or with any one or more of the other partners, as soon as the effective reaction temperature has been reached. The formaldehyde component can, for example, be added gradually during the reaction alone or with parts of the amine or the phosphorous acid.

In yet another operational sequence, the reaction can be conducted in a combined distillation and pressure arrangement. Specifically, the reaction vessel containing the reactant mixture is kept under ambient pressure at the selected reaction temperature. The mixture is then, possibly continuously, circulated through a reactor operated under autogeneous (autoclave principle) pressure built up thereby gradually adding the formaldehyde component or additional reaction partners in accordance with needs. In a particular execution, the closed reactor can contain a heterogeneous Broensted catalyst in whatever configuration is routinely suitable for the contemplated reaction. The reaction is substantially completed under pressure and the reaction mixture then leaves the closed vessel and is recirculated into the reactor where distillation of water and other non-reacted ingredients can occur depending upon the reaction variables, particularly the temperature.

The foregoing process variables thus show that the reaction can be conducted by a variety of substantially complementary arrangements. The reaction can thus be conducted as a batch process by heating the initial reactants, usually the phosphorous acid, the amine (II) and the aminopolyalkylene phosphonic acid catalyst in a (1) closed vessel under autogeneous pressure built up, or (2) under reflux conditions, or (3) under distillation of water and minimal amounts of non-reacted formaldehyde component, to a temperature preferably in the range of from 70° C. to 150° C. whereby the formaldehyde component is added, as illustrated in the Examples, gradually during the reaction. In a particularly preferred embodiment, the reaction is conducted in a closed vessel at a temperature in the range of from 100° C. to 150° C., coinciding particularly with the gradual addition of formaldehyde, within a time duration of from 1 minute to 30 minutes, in a more preferred execution from 1 minute to 10 minutes.

In another approach, the reaction is conducted as a continuous process, possibly under autogeneous pressure, whereby the reactants are continously injected into the reaction mixture, at a temperature preferably in the range of from 70° C. to 150° C. and the phosphonic acid reaction product is withdrawn on a continuous basis.

In yet another arrangement, the method can be represented by a semi-continuous setup whereby the phosphonic acid reaction is conducted continuously whereas preliminary reactions between part of the components can be conducted batch-wise.

The essential amine component (II) needed for synthesizing the inventive aminopolyalkylene phosphonic acids can be represented by a wide variety of known species. Examples of preferred amines include: ammonia; alkylene amines; alkoxy amines; halogen substituted alkyl amines; alkyl amines; aryl amines; and alkanol amines. The amine component can also be represented by amino acids, such as α-, β-, γ-, δ-, ε-, etc. amino acids, such as arginine, histidine, iso-leucine, leucine, methionine, threonine, phenylalanine, D,L-alanine, L-alanine, L-lysine, L-cysteine, L-glutamic acid, 7-aminoheptanoic acid, 6-aminohexanoic acid, 5-aminopentanoic acid, 4-aminobutyric acid and β-alanine. It is understood that poly species are embraced. As an example, the term “alkyl amines” also includes -polyalkyl amines-, -alkyl polyamines- and -polyalkyl polyamines-.

Individual species of amines of interest include: ammonia; ethylene diamine; diethylene triamine; triethylene tetraamine; tetraethylene pentamine; hexamethylene diamine; dihexamethylene triamine; 1,3-propane diamine-N,N′-bis(2-aminomethyl); polyether amines and polyether polyamines; 2-chloroethyl amine; 3-chloropropyl amine; 4-chlorobutyl amine; primary or secondary amines with C₁-C₂₅ linear or branched or cyclic hydrocarbon chains, in particular morpholine; n-butylamine; isopropyl amine; cyclohexyl amine; laurylamine; stearyl amine; and oleylamine; polyvinyl amines; polyethylene imine, branched or linear or mixtures thereof; ethanolamine; diethanolamine; propanolamine; dipropanol amine, D,L-alanine, L-alanine, L-lysine, L-cysteine, L-glutamic acid, 7-aminoheptanoic acid, 6-aminohexanoic acid, 5-aminopentanoic acid, 4-aminobutyric acid and β-alanine.

The essential formaldehyde component is a well known commodity ingredient. Formaldehyde sensu stricto known as oxymethylene having the formula CH₂O is produced and sold as water solutions containing variable, frequently minor, e.g. 0.3-3%, amounts of methanol and are typically reported on a 37% formaldehyde basis although different concentrations can be used. Formaldehyde solutions exist as a mixture of oligomers. Such formaldehyde precursors can, for example, be represented by paraformaldehyde, a solid mixture of linear poly(oxymethylene glycols) of usually fairly short, n=8-100, chain length, and cyclic trimers and tetramers of formaldehyde designated by the terms trioxane and tetraoxane respectively.

The formaldehyde component can also be represented by aldehydes and ketones having the formula R₁R₂C═O wherein R₁ and R₂ can be identical or different and are selected from the group of hydrogen and organic radicals. When R₁ is hydrogen, the material is an aldehyde. When both R₁ and R₂ are organic radicals, the material is a ketone. Species of useful aldehydes are, in addition to formaldehyde, acetaldehyde, caproaldehyde, nicotinealdehyde, crotonaldehyde, glutaraldehyde, p-tolualdehyde, benzaldehyde, naphthaldehyde and 3-aminobenzaldehyde. Suitable ketone species for use herein are acetone, methylethylketone, 2-pentanone, butyrone, acetophenone and 2-acetonyl cyclohexanone.

Preferably the formaldehyde component is oxymethylene, or an oligomer or polymer thereof.

The aminopolyalkylene phosphonic acid reaction product can subsequently, and in accordance with needs, be neutralized, in part or in total, with ammonia, amines, alkali hydroxides, earth-alkali hydroxides or mixtures thereof.

The invention is further illustrated by the following examples without limiting it thereby.

### EXAMPLES

### Example 1

In a three-necked round-bottom flask equipped with a mechanical stirrer and a Dean-Stark tube, 30.5 mL of a 32 wt.-% aqueous ammonia solution (0.5 mol) was mixed to 123 g (1.5 mol, 3 eq.) of phosphorous acid, 20 mL of water and 90 mL of a solution containing ˜40 wt.-% of ATMP (aminotri(methylene phosphonic acid)) (0.15 mol, 0.3 eq. ATMP as catalyst). ATMP has three phosphonic acid groups with the following acidity constants <2, <2, 4.3, 5.46, 6.6, 12.3. The reacting medium was heated to reflux and water was distilled through the Dean-Stark until the temperature of the reacting medium reached 135° C. 130 mL of a 36.6 wt.-% aqueous solution of formaldehyde (3.45 eq.) was then added over 185 min. During the addition 103 mL of water were removed from the reacting medium through the Dean-Stark tube, keeping the temperature of the reacting medium between 123 and 135° C. After the addition of formaldehyde was completed, the reacting medium was kept under reflux for one hour. Analysis by ³¹P NMR of the reacting medium showed that ATMP was formed in 70% yield.

### Example 2

In a three-necked round-bottom flask equipped with a mechanical stirrer and a Dean-Stark, 30.5 mL of a 32 wt.-% aqueous ammonia solution (0.5 mol) was mixed to 123 g (1.5 mol, 3 eq.) of phosphorous acid, 20 mL of water and 150 mL of a solution containing ˜40 wt.-% of ATMP (0.25 mol, 0.5 eq. ATMP as catalyst). The reacting medium was heated to reflux and water was distilled through the Dean-Stark until the temperature of the reacting medium reached 136° C. 130 mL of a 36.6 wt.-% aqueous solution of formaldehyde (3.45 eq.) was then added over 210 min. During the addition 116 mL of water was removed from the reacting medium through the Dean-Stark, keeping the temperature of the reacting medium between 126 and 136° C. After the addition of formaldehyde was completed the reacting medium was kept under reflux for 30 minutes. Analysis by ³¹P NMR of the reacting medium showed that ATMP was formed in 72% yield.

### Example 3

In a three-necked round-bottom flask equipped with a mechanical stirrer and a Dean-Stark, 30.5 mL of a 32 wt.-% aqueous ammonia solution (0.5 mol) was mixed to 123 g (1.5 mol, 3 eq.) of phosphorous acid, 20 mL of water, 90 mL of a solution containing ˜40 wt.-% of ATMP (0.15 mol, 0.3 eq. ATMP as catalyst) and 0.15 mol of Amberlyst 36 (0.3 eq.). The reacting medium was heated to reflux and water was distilled through the Dean-Stark until the temperature of the reacting medium reached 125° C. 129.7 mL of a 36.6 wt.-% aqueous solution of formaldehyde (3.45 eq.) was then added over 210 min. During the addition 89 mL water was removed from the reacting medium through the Dean-Stark, keeping the temperature of the reacting medium between 122 and 128° C. After the addition of formaldehyde was completed the reacting medium was kept under reflux for one hour. Analysis by ³¹P NMR of the reacting medium showed that ATMP was formed in 67% yield.

### Example 4

In a three-necked round-bottom flask equipped with a mechanical stirrer and a Dean-Stark tube, 40.26 g (0.2 moles) of 11-amino undecanoic acid were mixed with 32.8 g (0.4 mol, 2 eq.) of phosphorous acid, 20 mL of water and 77.86g (0.2 moles) of 11-amino undecanoic acid bis (methylene phosphonic acid). The reaction mixture was heated to reflux and 33 mL of a 36.6% w/w aqueous solution of formaldehyde (0.44 moles) were then added over 110 minutes. During the addition 37 mL of water were removed from the reaction mixture through the Dean-Stark tube while keeping the temperature of the reaction mixture between 105 and 116° C. Analysis by ³¹P NMR of the reaction mixture showed that a newly formed 11-amino undecanoic acid bis (methylene phosphonic acid) was formed in 51% yield with 21% of unreacted phosphorous acid.

### Example 5

In a three-necked round-bottom flask equipped with a mechanical stirrer and a Dean-Stark tube, 32.80 g (0.25 moles) of 6-amino hexanoic acid were mixed with 41 g (0.5 mol, 2 eq.) of phosphorous acid, 45 mL of water and 47.88 g (0.15 moles) of 6-amino hexanoic acid bis (methylene phosphonic acid). The reaction mixture was heated to reflux and 20.68 mL of a 36.6% w/w aqueous solution of formaldehyde (0.275 moles) were then added over 130 minutes. During the addition 38 mL of water were removed from the reaction mixture through the Dean-Stark tube while keeping the temperature of the reaction mixture between 113 and 125° C. After completion of formaldehyde addition the reaction mixture was kept under reflux for 15 minutes. Analysis by ³¹P NMR of the reaction mixture showed that a newly formed 6-amino hexanoic acid bis (methylene phosphonic acid) was formed in 67.2% yield with 9.1% of unreacted phosphorous acid.

1. A method for the manufacture of aminopolyalkylene phosphonic acid having the general formula (I),
(X)ₐ[N(W)(Y)₂₋ₐ]_{z} (I)
wherein X is selected from C₁-C₂₀₀₀₀₀ linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOG, F, Br, Cl, I, OG, SO₃H, SO₃G and/or SG moieties; ZPO₃M₂; [V—N(K)]—K; [V-N(Y)],—V or [V—O]ₓ—V; wherein V is selected from: C₂₋₅₀ linear, branched, cyclic or aromatic hydrocarbon radicals, optionally substituted by one or more C₁₋₁₂ linear, branched, cyclic or aromatic groups, which radicals and/or groups are optionally substituted by OH, COOH, COOR′, F/Br/C1/I, OR′, SO₃H, SO₃R′ and/or SR′ moieties, wherein R′ is a C₁₋₁₂ linear, branched, cyclic or aromatic hydrocarbon radical, wherein G is selected from C₁-C₂₀₀₀₀₀ linear, branched, cyclic or aromatic hydrocarbon radicals, optionally substituted by one or more C₁-C₁₂ linear, branched, cyclic or aromatic groups which radicals and/or which groups are optionally substituted by OH, COOH, COOR', F, Br, Cl, I, OR′, SO₃H, SO₃R′ and/or SR′ moieties; ZPO₃M₂; [V—N(K)]ₙ—K; [V—N(Y)]ₙ—V or [V—O]ₓ—V; wherein Y is ZPO₃M₂, [V—N(K)]ₙ—K or [V—N(K)]ₙ—V; and x is an integer from 1-50000; z is from 0-200000, whereby z is equal to or smaller than the number of carbon atoms in X, and a is 0 or 1; n is an integer from 0 to 50000; z=1 when a=0; and X is [V—N(K)]ₙ—K wherein n is an integer from 1 to 50000, or [V—N(Y)]ₙ—V wherein n is an integer from 2 to 50000 when z=0 and a=1;
Z is a C₁₋₆ alkylene chain;
M is selected from H, protonated amine, ammonium, alkali and earth-alkali cations;
W is ZPO₃M₂;
K is ZPO₃M₂;
starting from the following ingredients:
(a) phosphorous acid or an aqueous solution thereof;
(b) an amine or an aqueous solution thereof;
(c) formaldehyde or an aqueous solution thereof; and
(d) an aminopolyalkylene phosphonic acid catalyst or an aqueous solution thereof;
whereby (a), (b) and (d) are mixed followed by the addition of formaldehyde (c);
wherein the amine has the general formula (II)
(X)_{b}[N(W)(H)_{2-b}]_{z} (II)
wherein X is selected from C₁-C₂₀₀₀₀₀ linear, branched, cyclic or aromatic hydrocarbon radicals, optionally substituted by one or more C₁-C₁₂ linear, branched, cyclic or aromatic groups which radicals and/or which groups are optionally substituted by OH, COOH, COOG, F, Br, Cl, I, OG, SO₃H, SO₃G and/or SG moieties; H; [V—N(H)]ₓ—H ; [V—N(Y)]ₙ—V; [V—O]ₓ—V; wherein V is selected from: C₂₋₅₀ linear, branched, cyclic or aromatic hydrocarbon radicals, optionally substituted by one or more C₁₋₁₂ linear, branched, cyclic or aromatic groups, which radicals and/or groups are optionally substituted by OH, COOH, COOR′, F/Br/Cl/I, OR′, SO₃H, SO₃R′ and/or SR′ moieties, wherein R′ is a C₁₋₁₂ linear, branched, cyclic or aromatic hydrocarbon radical, wherein G is selected from C₁-C₂₀₀₀₀₀ linear, branched, cyclic or aromatic hydrocarbon radicals, optionally substituted by one or more C₁-C₁₂ linear, branched, cyclic or aromatic groups, which radicals and/or which groups are optionally substituted by OH, COOH, COOR′, F, Br, Cl, I, OR′, SO₃H, SO₃R′ and/or SR′ moieties; H; [V—N(H)]ₙ—H; [V—N(Y)]ₙ—V or [V—O]ₓ—V; wherein Y is H, [V—N(H)]ₙ—H or [V—N(H)]ₙ—V and x is an integer from 1-50000, n is an integer from 0 to 50000; z is from 0-200000 whereby z is equal to or smaller than the number of carbon atoms in X, and b is 0 or 1; z=1 when b=0; and X is [V—N(H)]_{X}H or [V—N(Y)]ₙ—V and n is an integer from 1 to 50000 when z=0 and b=1; z=1 when X is H.
W is H;
wherein the aminopolyalkylene phosphonic acid catalyst (d) has a general formula which is identical to the general formula of the aminopolyalkylene phosphonic acid (II) to be manufactured; and wherein the sum of the number of phosphonic acid groups in the aminopolyalkylene phosphonic acid (d) is greater than, by at least one (integer), the sum of the number of N atoms in said aminopolyalkylene phosphonic acid (d) catalyst;
whereby the ratios of (a) phosphorous acid, (b) amine, (d) aminopolyalkylene phosphonic acid and (c) formaldehyde, are as follows:
(a):(b) of from 0.05:1 to 2:1;
(c):(b) of from 0.05:1 to 5:1;
(c):(a) of from 5:1 to 0.25:1; and
(b):(d) of from 30:1 to 1:2;
wherein (a) and (c) stand for the number of moles and (b) represents the number of moles multiplied by the number of N—H functions in the amine and (d) stands, for the homogeneous aminopolyalkylene phosphonic acid expressed in number of moles;
conducting the reaction at a temperature of from 45° C. to 200° C. for a period of from 1 minute to 10 hours to thus yield the amino polyalkylene phosphonic acid.

2. The method in accordance with claim 1, wherein the amine (II) is selected from: ammonia; alkylene amines; alkoxy amines; halogen substituted alkyl amines;
alkyl amines; alkanol amines; polyethylene imine; polyvinyl amine; and amino acids.

3. The method in accordance with claim 2 wherein the amine is selected from: ammonia; ethylene diamine; diethylene triamine; triethylene tetraamine;
tetraethylene pentamine; hexamethylene diamine; dihexamethylene triamine; 1,3-propane diamine-N,N′-bis(2-aminomethyl); polyether amines and polyether polyamines; 2-chloroethyl amine; 3-chloropropyl amine; 4-chlorobutyl amine; primary or secondary amines with C₁-C₂₅ linear or branched or cyclic hydrocarbon chains, in particular morpholine; n-butylamine; isopropyl amine; cyclohexyl amine; laurylamine; stearyl amine; and oleylamine; polyvinyl amines; polyethylene imine, branched or linear or mixtures thereof; ethanolamine; diethanolamine; propanolamine; dipropanol amine, D,L-alanine, L-alanine, L-lysine, L-cysteine, L-glutamic acid, 7-aminoheptanoic acid, 6-aminohexanoic acid, 5-aminopentanoic acid, 4-aminobutyric acid and β-alanine.

4. The method in accordance with claim 1, wherein the aminopolyalkylene phosphonic acid catalyst (d) is structurally identical to the aminopolyalkylene phosphonic acid to be manufactured.

5. The method in accordance with claim 1, wherein the phosphonic acid catalyst (d) is represented by a mixture of 50% or more of the aminopolyalkylene phosphonic acid and from less than 50% of a heterogeneous Broensted acid, the degree of substitution being expressed as the number of proton equivalents in the Broensted acid versus the number of moles of aminopolyalkylene phosphonic acid to be replaced multiplied by the number of PO₃H₂ groups in the phosphonic acid minus the number of nitrogens, corresponding to the formula:
APP^{m}(PH^{m}−N^{m});
wherein:
number of mole(s) of aminopolyalkylene phosphonic acid to be replaced=APP^{m};
number of PO₃H₂ groups in the phosphonic acid=PH^{m};
number of nitrogen atoms in the aminopolyalkylene phosphonic acid catalyst=N^{m}.

6. The method in accordance with claim 5 wherein catalyst (d) is represented by a mixture of the aminopolyalkylene phosphonic acid in a level of from 60 to 90% and the heterogeneous Broensted acid in a level of from 10 to 40%.

7. The method in accordance with claim 5, wherein the heterogeneous Broensted acid catalyst is selected from the group of:
(1) solid acidic metal oxide combinations as such or supported onto a carrier material;
(2) cation exchange resins selected from the group comprising copolymers of styrene, ethylvinyl benzene and divinyl benzene, functionalized so as to graft SO₃H moieties onto the aromatic group and perfluorinated resins carrying carboxylic and/or sulfonic acid groups;
(3) organic sulfonic and carboxylic and phosphonic Broensted acids which are substantially immiscible in the reaction medium at the reaction temperature;
(4) an acid catalyst derived from:
(i) the interaction of a solid support having a lone pair of electrons onto which is deposited an organic Broensted acid; or
(ii) the interaction of a solid support having a lone pair of electrons onto which is deposited a compound having a Lewis acid site;
(iii) heterogeneous solids functionalized by chemical grafting with a Broensted acid group or a precursor therefore, and
(5) heterogeneous heteropolyacids of the general formula HₓPM_{y}O_{z} wherein P is selected from phosphorus and silicon and M is selected from W and Mo and combinations thereof.

8. The method in accordance with claim 1 wherein the reaction is carried out at a temperature in the range of from 70° C. to 150° C. combined with an approach selected from:
conducting the reaction under ambient pressure with or without distillation of water and non-reacted formaldehyde component;
in a closed vessel under autogenous pressure built up;
in a combined distillation and pressure arrangement whereby the reaction vessel containing the reactant mixture is kept under ambient pressure at the reaction temperature followed by circulating the reaction mixture through a reactor operated under autogeneous pressure built up thereby gradually adding the formaldehyde and other selected reactants in accordance with needs; and
a continuous process arrangement, possibly under autogeneous pressure built up, whereby the reactants are continuously injected into the reaction mixture and the phosphonic acid reaction product is withdrawn on a continuous basis.

9. The method in accordance with claim 8 wherein the reaction is conducted in a closed vessel at a temperature in the range from 75° C. to 200° C. for a period of from 1 to 60 minutes.

10. The method in accordance with claim 1 wherein the reactant/catalyst ratios are:
(a):(b) of from 0.1:1 to 1.50:1;
(c):(b) of from 0.2:1 to 2:1;
(c):(a) of from 3:1 to 0.5:1; and
(b):(d) of from 20:1 to 1:2.

11. The method in accordance with claim 1, wherein the reaction is conducted at a temperature in the range of from 115° C. to 145° C.

12. The method in accordance with claim 1 wherein the phosphorous acid is prepared starting from PCl₃, and contains less than 400 ppm of chlorine, expressed in relation to the phosphorous acid (100%).

13. The method in accordance with claim 1 wherein the phosphorous reactant (a) is prepared by adding P₄O₆ to an aqueous reaction medium containing the aminopolyalkylene phosphonic acid catalyst (d) whereby the P₄O₆ will substantially hydrolyse to phosphorous acid, said reaction medium having a pH which is at all times below 5, whereby the level of catalyst (d) is such to satisfy the pH requirement, said reaction medium being selected from:
i: an aqueous reaction medium containing the amine reactant (b);
ii: an aqueous reaction medium to which the amine reactant is added simultaneously with the P₄O₆; and
iii: an aqueous reaction medium wherein the amine is added after the addition/hydrolysis of the P₄O₆ has been completed.

14. The method in accordance with claim 13 comprising reacting the P₄O₆ hydrolysate, the amine and the aminopolyalkylene phosphonic acid (d), at a temperature in the range from 45° C. to 200° C., under gradual addition of formaldehyde, in an arrangement selected from:
a closed vessel under autogeneous pressure built up;
an open vessel under reflux conditions; or
under distillation of water and minimal amounts of non-reacted formaldehyde.

15. The method in accordance with claim 13 wherein the P₄O₆ hydrolysis and the reaction of the P₄O₆ hydrolysate, the amine and catalyst (d) with the formaldehyde is conducted in a single continuous manner, possibly under autogeneous pressure built up, at a temperature from 45° C. to 200° C. and the phosphonic acid reaction product is withdrawn on a continuous basis.

16. The method in accordance with claim 13 wherein the P₄O₆ hydrolysis is conducted in a batch reactor under ambient pressure followed by circulating the P₄O₆ hydrolysate, the amine and the catalyst (d) through a reactor containing the heterogeneous Broensted acid catalyst under autogeneous pressure built up at a temperature from 70° C. to 200° C., under gradual addition of the formaldehyde, followed by returning the mixture to the batch reactor at ambient pressure and a temperature from 70° C. to 200° C. to thus eliminate part of the water and non-reacted ingredients.

17. The method in accordance with claim 13 wherein the P₄O₆ is manufactured by reacting oxygen and phosphorus in essentially stoichiometric amounts in a reaction unit at a temperature in the range of from 1600 to 2000° K with a reaction residence time from 0.5 to 60 seconds, followed by quenching the reaction product at a temperature below 700° K and refining the reaction product by distillation.

18. The method in accordance with claim 17 wherein the level of elementary phosphorus in the P₄O₆ is below 1000 ppm, expressed in relation to P₄O₆ (100%).
